(19) United States
(12) Patent Application Publication
(10) Pub. No.: US 2001/0030501 A1
(43) Pub. Date: Oct. 18, 2001

(54) Electron gun and color cathode-ray tube having uniform image resolution

(75) Inventor: Akira Nakanishi, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/829,909

(22) Filed: Apr. 11, 2001

(30) Foreign Application Priority Data
Apr. 13, 2000 (JP) 2000-117165

(51) Int. Cl. H01J 29/50

(52) U.S. Cl. 313/414; 313/417

(57) ABSTRACT

An in-line electron gun and a color cathode-ray tube using the same. The electron gun comprises cathodes which are disposed in line for emitting electron beams corresponding to different colors, and a focusing electrode for focusing the electron beams; a final acceleration electrode for accelerating the electron beams passed through the focusing electrode. The electron gun comprises astigmatism compensation electrodes which have eaves shape and extend toward main axes of the electron gun and which are disposed at upper and lower portions of apertures of the final acceleration electrode for passing therethrough electron beams emitted from the cathodes on both outsides of the electron gun. The astigmatism compensation electrodes may be pairs of parallel plate electrodes which are disposed in a horizontal direction and at a predetermined distance from each other.

### FIELD OF THE INVENTION

The present invention relates generally to an electron gun and a color cathode-ray tube (or a color Braun tube) using the electron gun. More particularly, the present invention relates to a structure of an in-line electron gun for a color cathode-ray tube which provides electron beam spots having a uniform spot size on whole area of an image screen.

### BACKGROUND OF THE INVENTION

In order to improve image quality of an image displayed by a color cathode-ray tube, it is necessary to reduce a spot diameter or spot size of each electron beam and to converge each spot of three electron beams on one point throughout a whole area of an image screen. If at least one of these requirements is not fulfilled, resolution of the displayed image is decreased and the picture or image quality is deteriorated.

FIG. 7A and 7B schematically illustrate a magnetic field for horizontal deflection 72 and a magnetic field for vertical deflection 73 used in a conventional color cathode-ray tube, respectively. The magnetic field for horizontal deflection 72 is a “pincushion type” magnetic field, and the magnetic field for vertical deflection 73 is a “barrel type” magnetic field.

In FIG. 7A and FIG. 7B, there are shown electron beams 71R, 71G and 71B for red (R), green (G) and blue (B) respectively emitted from an in-line electron gun system including three electron guns disposed within the same plane of a horizontal direction. These electron beams 71R, 71G and 71B are deflected by a combination of the magnetic field for horizontal deflection 72 shown in FIG. 7A and the magnetic field for vertical deflection 73 shown in FIG. 7B, thereby the electron beams 71R, 71G and 71B for R, G and B are converged onto approximately one point at any portion on an image screen. This convergence system is called an in-line self convergence system.

The in-line self convergence system has the merits that an electric circuit, adjustment work and the like required for realizing convergence of the electron beams 71R, 71G and 71B for R, G and B can be decreased and the convergence can be realized with high precision.

However, when the R, G, B electron beams 71R, 71G and 71B pass through the pincushion type magnetic field for horizontal deflection 72 and the barrel type magnetic field for vertical deflection 73, these electron beams are influenced by the distorted distribution of these magnetic fields 72 and 73. As shown in FIG. 8, each of the electron beam spots on the image screen has a round shape in the center 81 of the image screen where the electron beams are not deflected. However, when each of the electron beams is deflected toward a peripheral portion of the image screen, the electron beam spot on the image screen becomes a distorted spot. The distorted spot includes a core portion 82 which has an oblong shape and which is shown by hatching, and a radial halo portion 83 spreading up and down from the core portion 82. Therefore, the size of the distorted electron beam spot in the peripheral portion of the image screen becomes larger than that of the round shaped electron beam spot 81 on the center of the image screen. Thus, the resolution at the peripheral portion is deteriorated.

In order to solve the above-mentioned problem, there is proposed a technology in which each of electron beams is previously deformed to an oblong shape in a triode section of an electron gun of a color cathode-ray tube. In this technology, a diameter in a vertical direction of each electron beam in the deflection magnetic field is decreased, and finally on the image screen the shape of the electron beam approximates to a round shape even in the peripheral portion. Thereby, it becomes possible to improve the image resolution at the peripheral portion of the image screen.

However, a recent color cathode-ray tube has a large picture size, a high resolution, a wide deflection angle, a flat image screen and the like. In such recent color cathode-ray tube, even if each of electron beams is previously deformed to an oblong shape in a triode section of an electron gun, electron beam spot sizes on the image screen vary depending on colors, that is, R, G and B, in the peripheral area of the image screen.

FIG. 9 schematically illustrates sizes of electron beam spots of R, G and B in this case, in the peripheral area of the image screen. As shown in FIG. 9, on the right side of the image screen, although the sizes of core portions of electron beam spots of R, G and B are substantially the same, the size of halo portions of electron beam spots of R is larger than the size of the halo portions of electron beam spots of G and B. Also, on the left side of the image screen, although the sizes of core portions of electron beam spots of R, G and B are substantially the same, the size of halo portions of electron beam spots of B is larger than the size of the halo portions of electron beam spots of R and G. Therefore, on the right side of the image screen, the size of the electron beam spots of R becomes larger than that of the electron beam spots of other colors, and on the left side of the image screen, the size of the electron beam spots of B becomes larger than that of the electron beam spots of other colors.

The reason for this is as follows. When the electron beams of R, G and B pass through a magnetic field for deflection, strengths of a self-convergence magnetic field applied to respective electron beams vary depending on the color of the electron beams. That is, there is astigmatism of the self convergence magnetic field. For example, when the electron beams of R, G and B are deflected toward the right side of the image screen, the electron beam of R undergoes a deflection magnetic field which is stronger than that of each of the electron beams of other colors in order to focus three electron beams onto approximately one point. As a result thereof, the electron beam spot size of R becomes larger than that of each of other colors G and B. On the other hand, when the electron beams of R, G and B are deflected toward the left side of the image screen, the electron beam of B undergoes a deflection magnetic field which is stronger than that of each of the electron beams of other colors and, therefore, the electron beam spot size of B becomes larger than that of each of other colors R and G.

Especially, in a recent color cathode-ray tube which has a large picture size, a high resolution, a wide deflection angle, and a flat image screen, when the electron beams of R, G and B pass through the deflection magnetic field, difference or variation of the strengths of the self-convergence magnetic field applied onto the electron beams of respective colors becomes large, and the above-mentioned phenomenon becomes prominent at the left and right end portions on the image screen so that resolution is deteriorated thereat.

### SUMMARY OF THE INVENTION

Therefore, it is an object of the present invention to obviate the disadvantages of a conventional electron gun and a color cathode-ray tube using the same.

It is another object of the present invention to provide an electron gun and a color cathode-ray tube using the same in which electron beam spot sizes corresponding to a plurality of colors can be unformed even in a peripheral area on an image screen.

It is still another object of the present invention to provide an electron gun and a color cathode-ray tube using the same in which a high image resolution can be realized throughout whole area of an image screen.

It is still another object of the present invention to provide an electron gun and an in-line three (3) beam type color cathode-ray tube using the same in which electron beam spot sizes corresponding to three electron beams can be unformed even in a peripheral area on an image screen.

It is still another object of the present invention to provide an electron gun and an in-line 3 beam type color cathode-ray tube using the same in which a high image resolution can be realized throughout whole area of an image screen.

According to an aspect of the present invention, there is provided an in-line electron gun for a color cathode-ray tube comprising: cathodes which are disposed in line for emitting electron beams corresponding to different colors; a focusing electrode for focusing the electron beams; a final acceleration electrode for accelerating the electron beams passed through the focusing electrode; and astigmatism compensation electrodes which have eaves shape and extend toward main axes of the electron gun and which are disposed at upper and lower portions of apertures of the final acceleration electrode for passing therethrough electron beams emitted from the cathodes on both outsides of the electron gun.

In this case, it is preferable that the astigmatism compensation electrodes comprise pairs of parallel plate electrodes, and, in each pair of the parallel plate electrodes, the plate electrodes are disposed in a horizontal direction and at a predetermined distance from each other.

It is also preferable that the different colors include red (R), green (G) and blue (B), and the astigmatism compensation electrodes are disposed at upper and lower portions of apertures of the final acceleration electrode for passing electron beams corresponding to R and B therethrough.

It is further preferable that tip portions of the astigmatism compensation electrodes are located at portions slightly retracted from the centers of the apertures of the final acceleration electrode for passing electron beams corresponding to R and B therethrough.

It is advantageous that the final acceleration electrode comprises a compensation electrode having apertures for passing electron beams corresponding to R, G and B therethrough, and the astigmatism compensation electrodes are disposed at upper and lower portions of apertures for passing electron beams corresponding to R and B therethrough, among the apertures for passing electron beams for R, G and B of the final acceleration electrode therethrough.

It is also advantageous that the astigmatism compensation electrodes are disposed on the side opposite from the cathodes with respect to the compensation electrode of the final acceleration electrode.

It is further advantageous that a main lens at the final stage of lens group of the electron gun is formed by the focusing electrode and the final acceleration electrode.

According to another aspect of the present invention, there is provided a color cathode-ray tube having at least an electron gun and an image screen, the electron gun comprising: cathodes which are disposed in line for emitting electron beams corresponding to different colors; a focusing electrode for focusing the electron beams; a final acceleration electrode for accelerating the electron beams passed through the focusing electrode; and astigmatism compensation electrodes which have eaves shape and extend toward main axes of the electron gun and which are disposed at upper and lower portions of apertures of the final acceleration electrode for passing therethrough electron beams emitted from the cathodes on both outsides of the electron gun.

In this case, it is preferable that the astigmatism compensation electrodes comprise pairs of parallel plate electrodes, and, in each pair of the parallel plate electrodes, the plate electrodes are disposed in a horizontal direction and at a predetermined distance from each other.

It is also preferable that the different colors include red (R), green (G) and blue (B), and the astigmatism compensation electrodes are disposed at upper and lower portions of apertures of the final acceleration electrode for passing electron beams corresponding to R and B therethrough.

It is further preferable that tip portions of the astigmatism compensation electrodes are located at portions slightly retracted from the centers of the apertures of the final acceleration electrode for passing electron beams corresponding to R and B therethrough.

It is advantageous that the final acceleration electrode comprises a compensation electrode having apertures for passing electron beams corresponding to R, G and B therethrough, and the astigmatism compensation electrodes are disposed at upper and lower portions of apertures for passing electron beams corresponding to R and B therethrough, among the apertures for passing electron beams for R, G and B of the final acceleration electrode therethrough.

It is also advantageous that the astigmatism compensation electrodes are disposed on the side of the image screen.

It is further advantageous that a main lens at the final stage of lens group of the electron gun is formed by the focusing electrode and the final acceleration electrode.

In the above-mentioned structure, by using the astigmatism compensation electrodes, there is formed a local vertical divergence lens at each of the outside portions of apertures for R electron beam and B electron beam. The local divergence lens diverges electron beams vertically. That is, the local divergence lens functions to cancel the astigmatism which the R electron beam and the B electron beam undergo when these electron beams pass through the self convergence deflection magnetic field. When the three electron beams are deflected toward peripheral portions of the image screen, only one of the R electron beam and B electron beam which has a larger deflection angle than that of the other electron beam passes through the local vertical divergence lens. As mentioned above, an electron beam having a large deflection angle is largely influenced by the astigmatism of the self convergence deflection magnetic field. However, such electron beam having a large deflection angle passes through the local vertical divergence lens, and undergoes an influence of the local vertical divergence lens which counteracts the astigmatism of the self convergence deflection magnetic field. Therefore, by appropriately selecting the strength or power of the local vertical divergence lens, it is possible to cancel the astigmatism of the self convergence deflection magnetic field by the local vertical divergence lens, and thereby to obviate the influence on the electron beams by the astigmatism of the self convergence deflection magnetic field. It is possible to change the electric field lens strength of the local vertical divergence lens by changing the shape, location and the like of the astigmatism compensation electrodes.

Because of the above-mentioned function, it is possible to correct imbalance of electron beam spot sizes on each of the left and right sides of the image screen and to mitigate deterioration of image resolution of R and B at the peripheral portions on the image screen. Therefore, by using the electron gun according to the present invention, it is possible to realize a color cathode-ray tube having high image quality in which image resolution of R, G and B is uniform throughout the whole area of the image screen.

### BRIEF DESCRIPTION OF THE DRAWINGS

These and other features, and advantages, of the present invention will be more clearly understood from the following detailed description taken in conjunction with the accompanying drawings, in which like reference numerals designate identical or corresponding parts throughout the figures, and in which:

FIG. 1 is a cross sectional view illustrating an electron gun according to an embodiment of the present invention;

FIG. 2 is a front view illustrating a final acceleration electrode of the electron gun according to an embodiment of the present invention;

FIG. 3A is a cross sectional view taken along the line A-A of FIG. 2, showing equipotential lines in the electron gun according to an embodiment of the present invention;

FIG. 3B is a cross sectional view taken along the line B-B of FIG. 2, showing equipotential lines in the electron gun according to an embodiment of the present invention;

FIG. 4A and FIG. 4B are schematic diagrams showing optical lens models of the electron gun according to an embodiment of the present invention;

FIG. 5 is a cross sectional view illustrating electron beam paths in the electron gun according to an embodiment of the present invention;

FIG. 6 is a front view illustrating an of image screen of a color cathode-ray tube which uses the electron gun according to an embodiment of the present invention;

FIG. 7A is a schematic illustration showing a distribution of a horizontal deflection magnetic field produced by a general deflection yoke;

FIG. 7B is a schematic illustration showing a distribution of a vertical deflection magnetic field produced by a general deflection yoke;

FIG. 8 is a front view illustrating an of image screen of a color cathode-ray tube which uses a conventional electron gun; and

FIG. 9 is a front view illustrating an of image screen of a color cathode-ray tube which uses another conventional electron gun.

### DESCRIPTION OF A PREFERRED EMBODIMENT

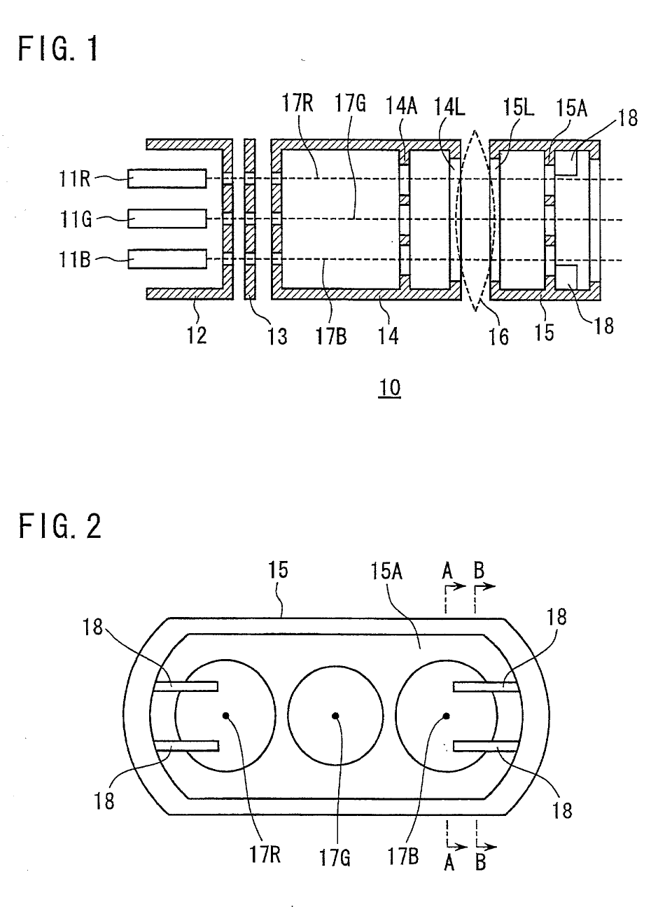

With reference to the drawings, an explanation will now be made on an electron gun according to an embodiment of the present invention. FIG. 1 is a cross sectional view showing an electron gun 10 for a color cathode-ray tube according to an embodiment of the present invention. In FIG. 1, reference symbols 11R, 11G and 11B designate cathodes which are disposed in line and which emit electron beams for red (R) color, green (G) color and blue (B) color, respectively. Reference symbols 17R, 17G and 17B designate electron beams for R, G and B, respectively.

The electron beams 17R, 17G and 17B emitted from the cathodes 11R, 11G and 11B pass through a control electrode 12, an acceleration electrode 13, a focusing electrode 14 and a final acceleration electrode 15, and thereafter reaches an image screen or a panel not shown in the drawing. The cathodes 11R, 11G and 11B, the control electrode 12 and the acceleration electrode 13 forms a triode portion of the color cathode-ray tube. Between the focusing electrode 14 and the final acceleration electrode 15, there is formed a main electron lens or a main lens 16.

In order to form the main lens 16, the focusing electrode 14 and the final acceleration electrode 15 have oblong or elongated circular apertures 14L and 15L, respectively, which are elongate in a lateral direction. The oblong apertures 14L and 15L are formed at end portions of the focusing electrode 14 and the final acceleration electrode 15 opposing to each other, and are commonly used by the electron beams 17R, 17G and 17B for R, G and B. Also, the focusing electrode 14 and the final acceleration electrode 15 have compensation electrodes 14A and 15A which are respectively formed at portions of the focusing electrode 14 and the final acceleration electrode 15 retreated from the oblong apertures 14L and 15L in opposite directions. By applying a low voltage to the focusing electrode 14 and a high voltage to the final acceleration electrode 15, the main lens 16 for focusing the electron beams 17R, 17G and 17B is formed. Although not described in detail, the electron gun 10 has a group of electron lens formed by various electrodes to produce necessary electron beams for R, G and B.

According to the present invention, there are provided astigmatism compensation electrodes 18 which have eaves shape. In this embodiment, the astigmatism compensation electrodes have parallel plate configuration. In each of the parallel plate electrodes, the plate electrodes are disposed in a horizontal direction and at a predetermined distance from each other. The astigmatism compensation electrodes 18 are provided on both side portions of the final acceleration electrode 15 and extend toward main axes of the electron gun 10. The astigmatism compensation electrodes 18 are provided at upper and lower portions of apertures for passing the R and B electron beams 17R and 17B of the compensation electrode 15A of the final acceleration electrode 15. In this embodiment, the astigmatism compensation electrodes 18 are provided on the corner portion of the compensation electrode 15A and the peripheral wall of the final acceleration electrode 15 on the side of the image screen not shown in the drawing.

FIG. 2 is a front view of the final access electrode 15 as seen from the side of the image screen not shown in the drawing. As shown in FIG. 2, the tip portions of the astigmatism compensation electrodes 18 are located at portions slightly retracted from the centers of the apertures of the compensation electrode 15A for passing the R and B electron beams 17R and 17B.

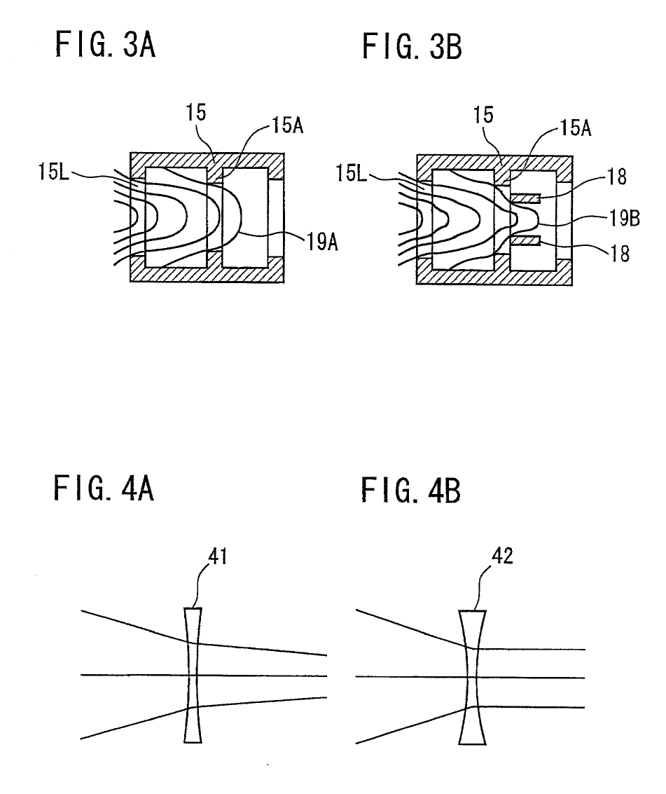

Next, with reference to FIG. 3A and FIG. 3B, an explanation will be made on an operation, effect and the like of the astigmatism compensation electrodes 18 according to the present invention. FIG. 3A is a cross sectional view showing equipotential lines 19A in the cross section A-A of FIG. 2, and FIG. 3B is a cross sectional view showing equipotential lines 19B in the cross section B-B of FIG. 2. In the cross section A-A of FIG. 2, since the astigmatism compensation electrodes 18 do not exist as shown in FIG. 3A, an electric field lens in vertical direction defined by the compensation electrode 15A is formed. On the other hand, in the cross section B-B of FIG. 2, since the astigmatism compensation electrodes 18 exist as shown in FIG. 3B, an electric field lens in vertical direction is formed which has larger strength or larger power than that of the electric field lens in the cross section A-A.

FIG. 4A shows an optical model of the electric field lens in vertical direction 41 in the cross section A-A of FIG. 2. FIG. 4B shows an optical model of the electric field lens in vertical direction 42 in the cross section B-B of FIG. 2. When compared with the electric field lens 41 in the vertical direction in the cross section A-A of FIG. 2, the electric field lens 42 in vertical direction in the cross section B-B of FIG. 2 has higher power of diverging an electron beam in the vertical direction. Therefore, the electric field lens 42 in vertical direction in the cross section B-B compensates the astigmatism caused by the deflection magnetic field stronger than the electron field lens 41 in the vertical lens in the cross section A-A. That is, when the electron beam passes through the cross section B-B of FIG. 2, the electron beam is more strongly astigmatism-compensated than when the electron beam passes through the cross section A-A of FIG. 2.

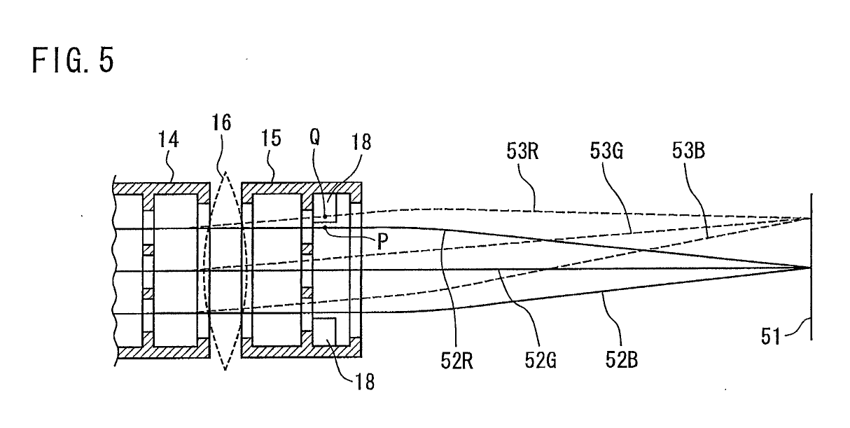

As shown in FIG. 5, when an electron beam is deflected toward a peripheral portion of an image screen 51 by the deflection magnetic field of the deflection yoke, since there exists a leakage magnetic field leaked onto the side of the electron gun, a deflection of the electron beam starts from inside the electron gun. That is, the paths of non-deflected electron beams 52R, 52G and 52G shown by solid lines differ from the paths of deflected electron beams 53R, 53G and 53G shown by dotted lines, already from within the focusing electrode 14 and the final acceleration electrode 15. Therefore, the R electron beam 52R which passes through a point P within the final acceleration electrode 15 when it is not deflected becomes the R electron beam 53R when it is deflected toward upside of FIG. 5 (toward right side in the image screen) and passes through a point Q.

At the point Q, there exists the strong vertical lens formed by the astigmatism compensation electrodes 18 as shown in FIG. 3B, and, therefore, the astigmatism of the R electron beam 53R is strongly compensated. Other electron beams 52G and 52B pass through portions where the astigmatism compensation electrodes 18 do not exist, that is, where the strong vertical lens formed by the astigmatism does not exist, and, therefore, the astigmatism of the G and B electron beams 53G and 53B is not compensated much, both in the deflected and non-deflected condition.

Therefore, when the electron beams are deflected toward upside as shown in FIG. 5 (toward right side in the actual image screen), only the R electron beam 53R is compensated for astigmatism, and when the electron beams are deflected toward downside of FIG. 5 (toward left side in the actual image screen), only the B electron beam 53B is compensated for astigmatism. Thereby, it is possible to obviate unevenness or imbalance of electron beam spot sizes of the R, G and B electron beams in the peripheral area of the image screen caused by the astigmatism of the magnetic field for self convergence. Thus, it is possible to realize high image resolution even in the peripheral area of the image screen.

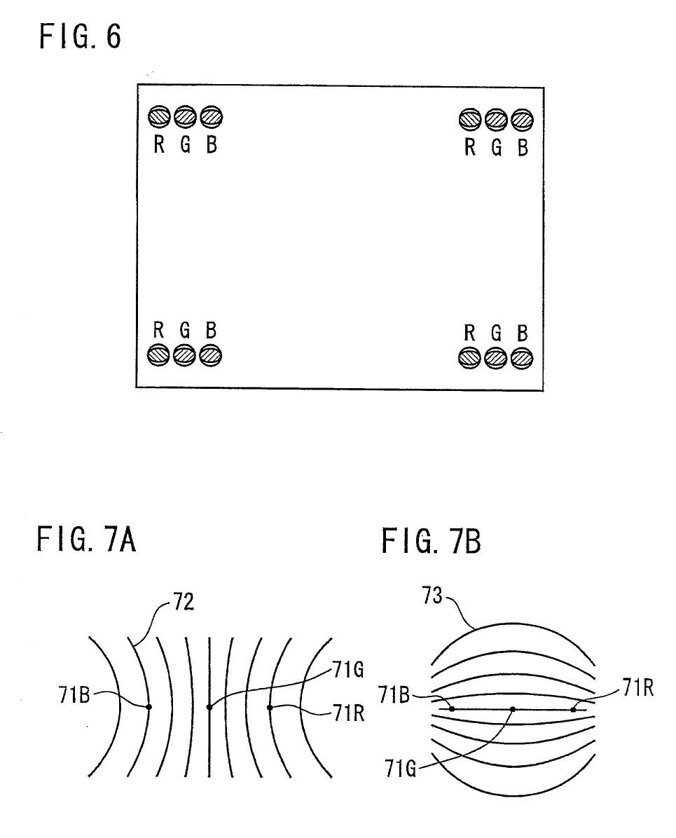

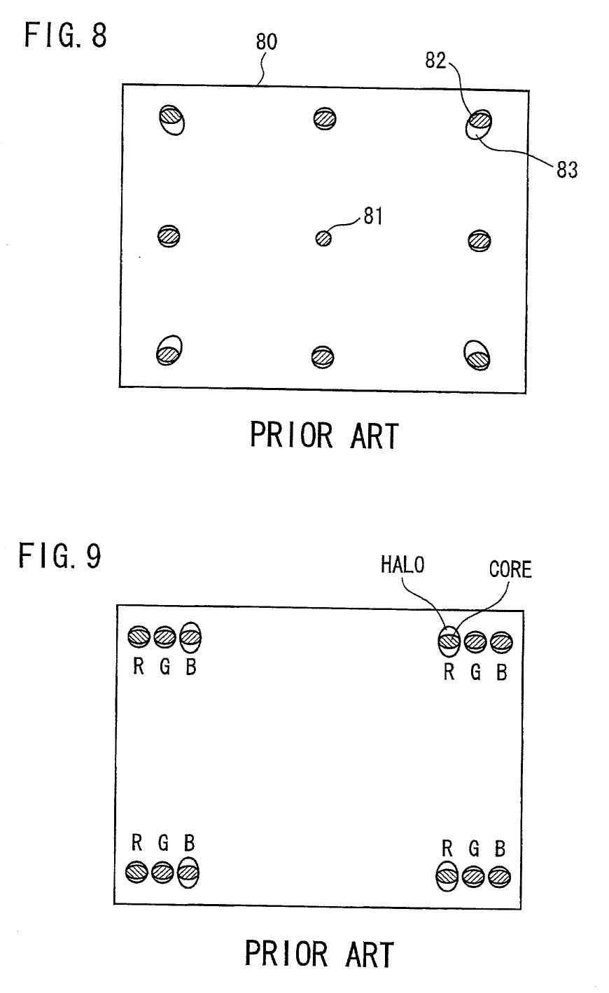

FIG. 6 schematically illustrates sizes of electron beam spots of R, G and B in the peripheral area of the image screen of the color cathode-ray tube which has the electron gun according to the present invention. As shown in FIG. 6, even in the peripheral area of the image screen, the sizes of core portions shown by hatching of electron beam spots of R, G and B are substantially the same, and also the sizes of halo portions of electron beam spots of R, G and B are substantially the same. Therefore, it is possible to obtain high image resolution even in the peripheral area of the image screen.

As mentioned above, in the color cathode-ray tube according to the present invention, it is possible to uniformalize the electron beam spot sizes of the R, G and B electron beams even in the peripheral area of the image screen. That is, in the conventional electron gun and the color cathode-ray tube, image resolution of R is deteriorated on the right side of the image screen and image resolution of B is deteriorated on the left side of the image screen. According to the present invention, such disadvantages can be avoided, and it becomes possible to realize a high quality color cathode-ray tube which has high image resolution throughout the whole area of the image screen.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative sense rather than a restrictive sense, and all such modifications are to be included within the scope of the present invention. Therefore, it is intended that this invention encompasses all of the variations and modifications as fall within the scope of the appended claims.

What is claimed is:

1. An in-line electron gun for a color cathode-ray tube comprising:
cathodes which are disposed in line for emitting electron beams corresponding to different colors;
a focusing electrode for focusing said electron beams;
a final acceleration electrode for accelerating said electron beams passed through said focusing electrode; and
astigmatism compensation electrodes which have eaves shape and extend toward main axes of said electron gun and which are disposed at upper and lower portions of apertures of said final acceleration electrode for passing therethrough electron beams emitted from said cathodes on both outsides of said electron gun.

2. An in-line electron gun for a color cathode-ray tube as set forth in claim 1, wherein said astigmatism compensation electrodes comprise pairs of parallel plate electrodes, and, in each pair of said parallel plate electrodes, said plate electrodes are disposed in a horizontal direction and at a predetermined distance from each other.

3. An in-line electron gun for a color cathode-ray tube as set forth in claim 1, wherein said different colors include red (R), green (G) and blue (B), and said astigmatism compensation electrodes are disposed at upper and lower portions of apertures of said final acceleration electrode for passing electron beams corresponding to R and B therethrough.

4. An in-line electron gun for a color cathode-ray tube as set forth in claim 1, wherein tip portions of said astigmatism compensation electrodes are located at portions slightly retracted from the centers of said apertures of said final acceleration electrode for passing electron beams corresponding to R and B therethrough.

5. An in-line electron gun for a color cathode-ray tube as set forth in claim 1, wherein said final acceleration electrode comprises a compensation electrode having apertures for passing electron beams corresponding to R, G and B therethrough, and said astigmatism compensation electrodes are disposed at upper and lower portions of apertures for passing electron beams corresponding to R and B therethrough, among said apertures for passing electron beams for R, G and B of said final acceleration electrode therethrough.

6. An in-line electron gun for a color cathode-ray tube as set forth in claim 5, wherein said astigmatism compensation electrodes are disposed on the side opposite from said cathodes with respect to said compensation electrode of said final acceleration electrode.

7. An in-line electron gun for a color cathode-ray tube as set forth in claim 1, wherein a main lens at the final stage of lens group of said electron gun is formed by said focusing electrode and said final acceleration electrode.

8. A color cathode-ray tube having at least an electron gun and an image screen, said electron gun comprising:
cathodes which are disposed in line for emitting electron beams corresponding to different colors;
a focusing electrode for focusing said electron beams;
a final acceleration electrode for accelerating said electron beams passed through said focusing electrode; and
astigmatism compensation electrodes which have eaves shape and extend toward main axes of said electron gun and which are disposed at upper and lower portions of apertures of said final acceleration electrode for passing therethrough electron beams emitted from said cathodes on both outsides of said electron gun.

9. A color cathode-ray tube as set forth in claim 8, wherein said astigmatism compensation electrodes comprise pairs of parallel plate electrodes, and, in each pair of said parallel plate electrodes, said plate electrodes are disposed in a horizontal direction and at a predetermined distance from each other.

10. A color cathode-ray tube as set forth in claim 8, wherein said different colors include red (R), green (G) and blue (B), and said astigmatism compensation electrodes are disposed at upper and lower portions of apertures of said final acceleration electrode for passing electron beams corresponding to R and B therethrough.

11. A color cathode-ray tube as set forth in claim 8, wherein tip portions of said astigmatism compensation electrodes are located at portions slightly retracted from the centers of said apertures of said final acceleration electrode for passing electron beams corresponding to R and B therethrough.

12. A color cathode-ray tube as set forth in claim 8, wherein said final acceleration electrode comprises a compensation electrode having apertures for passing electron beams corresponding to R, G and B therethrough, and said astigmatism compensation electrodes are disposed at upper and lower portions of apertures for passing electron beams corresponding to R and B therethrough, among said apertures for passing electron beams for R, G and B of said final acceleration electrode therethrough.

13. A color cathode-ray tube as set forth in claim 12, wherein said astigmatism compensation electrodes are disposed on the side of said image screen.

14. A color cathode-ray tube as set forth in claim 8, wherein a main lens at the final stage of lens group of said electron gun is formed by said focusing electrode and said final acceleration electrode.
